(19) United States
(12) Patent Application Publication
(10) Pub. No.: US 2007/0000892 A1
(43) Pub. Date: Jan. 4, 2007

(54) Gas nozzle for a welding torch, welding torch, and cleaning device for a welding torch

(76) Inventors: Georg Binder, Pettenbach (AT); Manfred Hubinger, Kremsmuenster (AT); Harald Langeder, Pettenbach (AT); Josef Raxendorfer, Steinerkirchen (AT)

Correspondence Address: WILLIAM COLLARD;COLLARD & ROE, P.C., 1077 NORTHERN BOULEVARD, ROSLYN, NY, 11576, US

(21) Appl. No.: 10/553,861

(22) PCT Filed: May 10, 2004
(86) PCT No.: PCT/AT04/00160

§ 371 Date: Oct. 20, 2005

(30) Foreign Application Priority Data
May 13, 2003 (AT) A 730/2003

(51) Int. Cl. B23K 9/16

(52) U.S. Cl. 219/136; 219/137.43

(57) ABSTRACT

The invention relates to a gas nozzle and to a welding torch equipped with the gas nozzle, a nozzle assembly and with a contact tube that have an artificially produced patina layer for the purpose of reducing the adhesion of welding spatters at least on a partial area of the surface thereof. The invention also relates to a cleaning device for welding torches having a brush provided with bristles. These bristles are made of a very soft elastic material, preferably plastic, and abrasive grains are embedded in the bristles.

The invention relates to a gas nozzle for a welding torch, which is made of copper or a copper alloy, as well as a welding torch including a gas nozzle, a nozzle assembly and a contact tube, wherein the gas nozzle and/or the nozzle assembly and/or the contact tube are made of copper or a copper alloy.

The invention further relates to a cleaning device for a welding torch and, in particular, its gas nozzle, which includes a brush provided with bristles for cleaning the welding torch of weld spatter.

During a welding procedure, welding torches are contaminated by molten metal spatters. Said metal spatters deposit on the exterior of the housing of the gas nozzle of the welding torch and even within the gas nozzle, solidifying there. As a result, the flow of the protective gas through the gas nozzle will be disturbed by the deposited metal spatters in a manner that atmospheric air too will reach the welding site, thus adversely affecting the welding process. It may, moreover, happen that short-circuits are caused by such welding spatters. For a high-quality weld, a perfectly functioning and largely clean welding torch is, therefore, essential. As a result, welding torches are cleaned of adhering spatters at regular intervals. During cleaning, the welding torch will not be available for welding operations. It is, therefore, aimed to perform cleaning as rapidly as possible.

From DE 44 26 303 C1 a non-stick agent against weld spatter is, for instance, known, which is comprised of a solution of a glycerol ester of an unsaturated C18-C20-fatty acid in a methyl or ethyl ester of such a fatty ester. That non-stick agent is applied to those parts of a welding torch, where the adherence of weld spatter is to be prevented.

It is, furthermore, feasible according to DE 195 07 472 C2 to apply a coating to the gas or current nozzle of a protective-gas welding apparatus, wherein the gas or current nozzle is made of a metal that is coated with a protective layer containing graphite and a polymer releasing carbon under heat exposure and/or a heat-resistant polymer.

A welding torch and a current nozzle or contact tube where a special coating is applied are known from DE 201 00 126 U1. The welding torch comprises an internally arranged nozzle assembly to whose end section facing the welding region a hollow current nozzle is attached, wherein a metallic non-stick and reflexion coating is provided on at least a portion of the surface of the current nozzle. The coating comprises silver as its main component.

Various mechanical methods have been available for the cleaning of a welding torch and, in particular, its gas nozzle, contact tube and nozzle assembly. Thus, deposits, i.e. weld spatters on the welding torch, are, for instance, removed by the aid of metal brushes, blades or the like. During mechanical cleaning, the structural components of the welding torch will be damaged by mechanical action, and their service lives will be reduced accordingly.

From EP 0 765 204 B a device for cleaning the heads or gas nozzles of welding torches is known, which device comprises an open container to which an ultrasonic generator is connected, said ultrasonic generator producing ultrasonic waves in a liquid. Furthermore, a rotary tool is arranged within the container. The tool may be comprised of a steel wire brush or a metal brush, in which the bristles of the brush are made of steel. The use of the brush, however, presupposes that the ring or spatter be separated from the housing by ultrasonic vibrations, i.e. ultrasonic waves, in a manner that the ring or spatter drops off the housing during brushing.

Furthermore, a device for cleaning a gas nozzle of a welding torch is known from DE 33 39 547 C, in which the outer contour of the brush is adapted to the shape of the gas nozzle inner surface to be cleaned. In that case the brush is comprised of a bristle strip arranged on a cylindrical shaft, which cylindrical shaft has a concentric nose of reduced outer diameter to fit into the bore that serves to fasten the gas nozzle to the welding torch. The shaft further comprises a handle stick such that the device can be manually inserted into the gas nozzle by a user so as to enable the cleaning of the gas nozzle or welding torch by the user.

Basically, it should be noted that there is still a plurality of other devices for cleaning gas nozzles of welding torches, by which cleaning is effected by the aid of crushing tools such as, for instance, milling tools or cutting tools. In those cases, the tool is introduced into the gas nozzle, and the spatter is peeled off the gas nozzle by such a tool, i.e., a miller or cutting element.

The systems known from the prior art involve the disadvantage that such mechanical cleaning devices will only enable the successful cleaning of gas nozzles if the spatter consists of a solid material and, in particular, steel or a steel alloy, which means that a welding process for joining workpieces of steel or steel alloys is performed such that the spatter will be formed of those materials. Otherwise, the application of the usual tools known from the prior art, i.e., a milling tool, a cutting tool or metal brushes, is impossible, since in welding processes using soft materials such as, for instance, aluminum, the spatter forming of aluminum cannot be readily removed from, or peeled off, the gas nozzle. In those cases, it will in fact happen that the spatter consisting of aluminum will not readily separate from the gas nozzle as a whole, but rather be spread by rubbing or smeared by the tool, which is why the cleaning quality of known tools leaves much to be desired.

The object of the present invention consists in reducing the spatterability of welding torches. Another object of the invention resides in providing an above-mentioned cleaning device for welding torches and, in particular, the gas nozzles of the same, especially when employing an aluminum welding process, by which the cleaning quality will be substantially improved, thus assisting automated cleaning, which is particularly suitable for welding robot applications. In addition, the device is to be constructed as simple and cost-effective as possible.

The object according to the invention is achieved in that the gas nozzle comprises an artificially produced patina layer at least on a partial area of its surface.

The object of the invention is, however, also achieved in that, in a welding torch, the gas nozzle and/or the nozzle assembly and/or the contact tube comprise an artificially produced patina layer at least on a partial area of the respective surface.

Among all surface coating methods, the generation of an oxidic layer from the parent metal (patina layer) yields a layer that exhibits the optimum adhesive properties, because the layer is not applied to the surface but stepwisely formed chemically of the parent metal already on a molecular plane at the grain boundaries of the texture.

This offers the advantage that the artificially produced patina layer in the event of a gas nozzle made of copper, or the copper components of a welding torch, constitutes a layer that is characterized by the presence of (OH)-groups. This oxygen compound creates a high surface tension, an elevated temperature resistance and a reduced wettability. In addition, this oxidation film on the copper surface prevents aluminum melt from penetrating into the surface pores and, hence, adhering thereto. Due to this effect, cleaning of the components is substantially facilitated too, since the weld spatters are actually very easily separated from the patina layer. Thus, hardly any damage to the surface will occur during cleaning of the components, whose service lives will consequently be largely increased. An essential advantageous, above all, resides in the fact that a very low spatter adherence is reached when using parts with patina layers in an aluminum welding process, since aluminum does not combine with the patina layer and the weld spatter will, thus, only very poorly adhere.

Further characteristic features are described in claims 3 and 4. The advantages resulting therefrom are to be taken from the description.

The object of the invention is further achieved in that the bristles of the brush of a cleaning device are formed of a very soft, elastic material, preferably a synthetic material, and that abrasives are embedded in said bristles. As a result, new grain or abrasives are constantly released from the bristles due to the wear of the brushes, thus providing a uniform abrasive effect over an extended period of time. It is, thus, also ensured that a constantly high cleaning quality will be achieved. Furthermore, the synthetic brushes are highly elastic and flexible, thus enabling better cleaning than metal brushes on sites that are difficult to accede like the interior of the welding torch, since the brushes are able to adapt to the shape of the gas nozzle. This effect, in particular, is achieved by the centrifugal force occurring at elevated speeds. A very essential advantage resides in that the surfaces of the parts to be cleaned, such as the gas nozzle, the contact tube or the nozzle assembly, will not be damaged or scratched to the same extent as by the tools known from the prior art and, in particular, steel brushes. The most essential advantage, however, resides in that, by such a configuration of the brush, the spatter adhering to the gas nozzle or welding torch is no longer simply peeled off as happens by milling tools, cutting tools or steel brushes, but the spatter is completely separated as a whole without any mechanical damage to the wear part surfaces.

In an advantageous manner, the bristles are provided with a coating in which abrasives are embedded.

Yet, a configuration according to claim 7 is of advantage too, because it enables the interior of the gas nozzle and the outer surface of the gas nozzle to be cleaned simultaneously in a single operation.

A configuration according to claim 8 is advantageous in that the bristles are able to reach far into the gas nozzle, i.e., into the interior of the gas nozzle, thus enabling very deep cleaning. It is also ensured that, due to the length of the bristles, their flexibility will be increased such that the bristles will readily adapt to the parts to be cleaned, thus providing an excellent cleaning quality.

The configuration according to claim 9 in an advantageous manner ensures that a simple and cost-effective structure of the cleaning device is achieved.

In the configuration according to claim 10, another advantage also resides in that, due to the angular orientation of the welding torch or gas nozzle relative to the brush, cleaning of a specially designed gas nozzle having a conically tapering shape is feasible.

A configuration according to claims 11 and 12 is also advantageous, since thereby shorter cleaning times will be obtained.

Yet, also a configuration according to claims 13 to 17 is of advantage, since is ensures the achievement of an excellent cleaning quality on account of the bristles being adaptable to the shape of the gas nozzle and, hence, permanently contacting the surfaces to be cleaned.

A configuration according to claim 18 is, however, also advantageous, since it prevents extensive pressing apart of the bristles.

The present invention will be explained in more detail by way of the accompanying drawings. Therein:

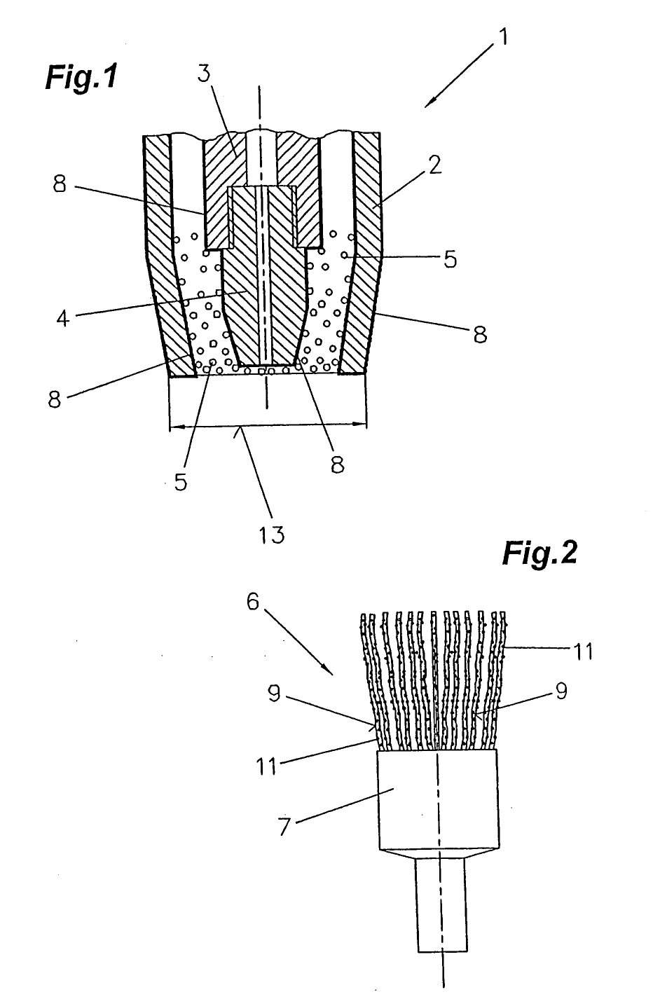

FIG. 1 is a partial cutout of a welding torch in a sectional and simplified, schematic illustration;

FIG. 2 is a side view of a brush for a cleaning device in a simplified, schematic illustration;

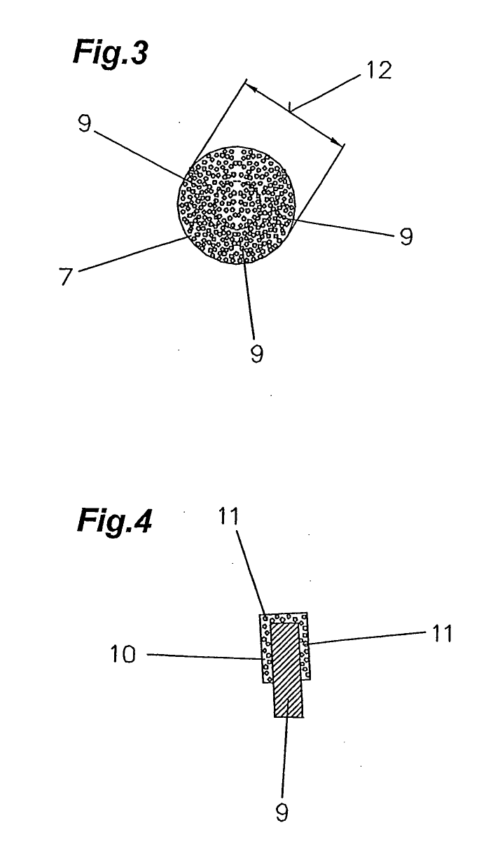

FIG. 3 is a top view on the brush in a simplified, schematic illustration;

FIG. 4 is a section through a bristle of the brush in a simplified, schematic illustration.

FIG. 1 shows a cutout and, in particular, an end region associated with the welding process, of a welding torch 1. The welding torch 1 comprises a gas nozzle 2, a nozzle assembly 3 and a contact tube 4. The other parts of the welding torch 1 have been omitted for the sake of clarity. Also is the structure or configuration of the illustrated parts not limited to the exemplary embodiment shown, and it is feasible to apply the solution according to the invention to any welding torch 1 known from the prior art, or parts thereof.

The gas nozzle 2 illustrated in FIG. 1 is made of copper or a copper alloy and detachably fastened to the welding torch 1. The contact tube 4 as well as the nozzle assembly 3, which are provided in various configurations in every welding torch, are likewise made of copper or a copper alloy, the contact tube 4 being detachably connected with the nozzle assembly 3. The description of the mode of functioning of these components and their tasks has been omitted, since these are sufficiently well-known from the prior art.

As already mentioned in the beginning, weld spatters 5 are formed during a welding process as schematically illustrated, which deposit on the gas nozzle 2, contact tube 4 and nozzle assembly 3 and remain adhering to these components. In longer-lasting welding processes it may, thus, happen that the welding torch 1 is partially or fully obstructed by such weld spatters 5 and the gas flow will consequently become irregular or completely interrupted, with the formation of short-circuits between the individual components being feasible. Since in conventional gas nozzles 2 made of copper, or the copper parts of a welding torch 1, the weld spatters 5 burn into the surface or melt to the same, it is frequently difficult to clean these parts because of the firm adherence and, hence, difficult separation of the weld spatters 5.

If, to make things worse, the welding torch 1 is used for aluminum welding, cleaning of the copper parts, particularly of the nozzle assembly 3 and the contact tube 4, or the gas nozzle 2, respectively, will be even more difficult, because aluminum weld spatters cannot be simply blast off or peeled off during cleaning. Aluminum weld spatters 5 have the property of not readily separating as a whole during cleaning but, due to the softness of the material, rather being smeared or spread by rubbing, which means that aluminium weld spatters 5 cannot be removed as a whole during cleaning by known cleaning devices such as, for instance, milling devices or brush devices including steel bristles, but are rather peeled off by such cleaning devices, thus being smeared or spread by rubbing.

Especially robotic applications effect automated cleaning of the welding torch 1, so that it has to be ensured that the weld spatters 5 are removed to the largest extent possible. To this end, a special tool 6, particularly a brush 7, for cleaning the welding torch 1 is described in more detail in FIGS. 2 to 4, which cleaning device is highly suitable especially for aluminum welding processes in connection with the configuration according to the invention of the gas nozzle 2 or welding torch 1, respectively, and, in particular, the nozzle assembly 3 and the contact tube 4.

The solution according to the invention now contemplates that the welding torch parts made of copper or copper alloys are specially treated with a view to reducing the stickability of weld spatters 5, i.e., strongly reducing spatter adherence. To this end, these parts and, in particular, the gas nozzle 2, the contact tube 4 and the nozzle assembly 3 are provided with an artificially produced patina layer 8.

A patina layer 8 will basically form by oxidation, if copper is exposed to the atmosphere over an extended period of time, yet such a patina layer 8 will only form after about 10 years. However, since such a long storage time enabling the build-up of a patina layer 8 is unprofitable, the parts are subjected to an artificial aging process to rapidly form said patina layer 8 within an extremely short time. The patina layer 8, in principle, is comprised of basic copper compounds, particularly copper carbonates and/or sulfates, which are formed by the reaction of copper with carbon or sulfur dioxides. The patina layer 8 has the property that, with the employment of such parts in an aluminum welding process, these will not combine with the aluminum, i.e., the aluminum weld spatters 5, so that the weld spatters 5 will be prevented from burning into, or melting to, the surface, thus providing a sealing protection. When using a patina layer 8, the spatter adherence is reduced by a factor of 5 to 10, whereby the service lives too of such parts provided with patina layers 8 will be substantially increased. The formation of a patina layer 8 also offers substantial advantages in the cleaning of such parts, because the weld spatters 5 will no longer burn into the surfaces of these parts, or melt to the same, so as to enable simple cleaning without causing damage to the surfaces of these parts.

Various modes of procedure may be envisaged to produce the patina layer 8. One way of producing an artificial patina layer 8 on the gas nozzle 2 and/or the nozzle assembly 3 and/or the contact tube 4 is described below. The copper parts are successively immersed into two solutions. The first solution is comprised of 1 liter water and 2 ml sulfurated potash. The second solution comprises again 1 liter water, 1 to 2 g copper sulfate and 10 ml sulfuric acid. The copper parts on which an artificial patina layer 8 is to be produced are then immersed into the first solution for some seconds. After this, the copper parts are rinsed and immersed into the second solution. This procedure is repeated several times, particularly 2 to 3 times. This procedure causes the copper part to change color thus forming the patina layer 8, said discoloration or patina layer 8 adhering very firmly to the parent metal of the copper parts, i.e., the gas nozzle 2, the nozzle assembly 3 and contact tube 4.

The patina layer 8 will be the thicker the more frequently this procedure is repeated. In a preferred manner, the patina layer 8 has a thickness ranging between 50 and 200 μm.

The patina layer 8 is at least provided on a partial region of the surface of the gas nozzle 2, which means that the patina layer 8 is formed at least in that area which is to be protected from weld spatter 5. The use of such gas nozzles 2, or the welding torch 1, with the patina layer 8 is recommended for aluminum welding processes as well as MIG soldering. It is, of course, feasible to use the welding torch 1 or gas nozzle 2 in other welding or soldering methods too.

FIGS. 2 to 4 depict a cleaning device, wherein the overall structure of the cleaning device is not illustrated, but only a tool 6 in the form of a brush 7. The cleaning device, for instance, comprises a housing which is designed like a box, in which all components provided for the cleaning of the welding torch 1, such as, for instance, a control unit, drive motors, monitoring means, interfaces for the connection to external components such as, for instance, a welding apparatus and/or a robot etc. are contained.

The cleaning device for the welding torch 1 and, in particular, its gas nozzle 2, nozzle assembly 3 and contact tube 4, which comprise a coating and, in particular, a patina layer 8 has been specifically designed for use in an aluminum welding process, which means that the parts to be welded consist of aluminum or aluminum alloys and an aluminum welding wire is used in the welding apparatus. For the cleaning of the gas nozzle 2 or welding torch 1, the cleaning device comprises the rotating tool 6 and, in particular, the brush 7, which is mechanically driven via a drive motor (not illustrated). The tool 6 is designed to be exchangeable in a simple manner. In order to clean the welding torch 1 and the gas nozzle 2, these are approached to the tool 6, and the gas nozzle 2 and welding torch 1 are freed of weld spatters 5 by the rotating tool 6. The approach of the welding torch 1 is preferably carried out by a robot. However, it is, of course, also feasible to use such a cleaning device manually, i.e., the welding torch 1 plus the gas nozzle 2 mounted thereto are manually brought to the tool 6 by a user.

In order to reach a high cleaning quality, the bristles 9 of the brush 7 are made of a very soft, elastic material, preferably a synthetic material. The bristles 9 are, moreover, provided with a coating 10 in which abrasives 11 are embedded. In a preferred manner, the bristles 9 of the brush 7 are comprised of one, or a combination, of the materials silicon carbide, polyvinyl chloride, nylon, polyamide, polypropylene, polyethylene or fibre. It will be of advantage if the bristles 9 are designed to be corrugated and, if desired, additionally plaited.

The brush 7 is preferably constructed in a manner that the diameter 12, or outer periphery, of the brush 7 is larger than the diameter 13, or outer periphery, of the gas nozzle 2 of the welding torch 1. It is thereby ensured that a portion of the bristles 9 of the brush 7 are able to reach into the interior of the gas nozzle 2 while, at the same time, bristles 9 contact the outer surface of the gas nozzle 2, so that the simultaneous cleaning of the interior and the outer surface of the gas nozzle 2 is carried out in a single operation. The bristles 9 of the brush 7 preferably have a length ranging between 15 mm and 50 mm.

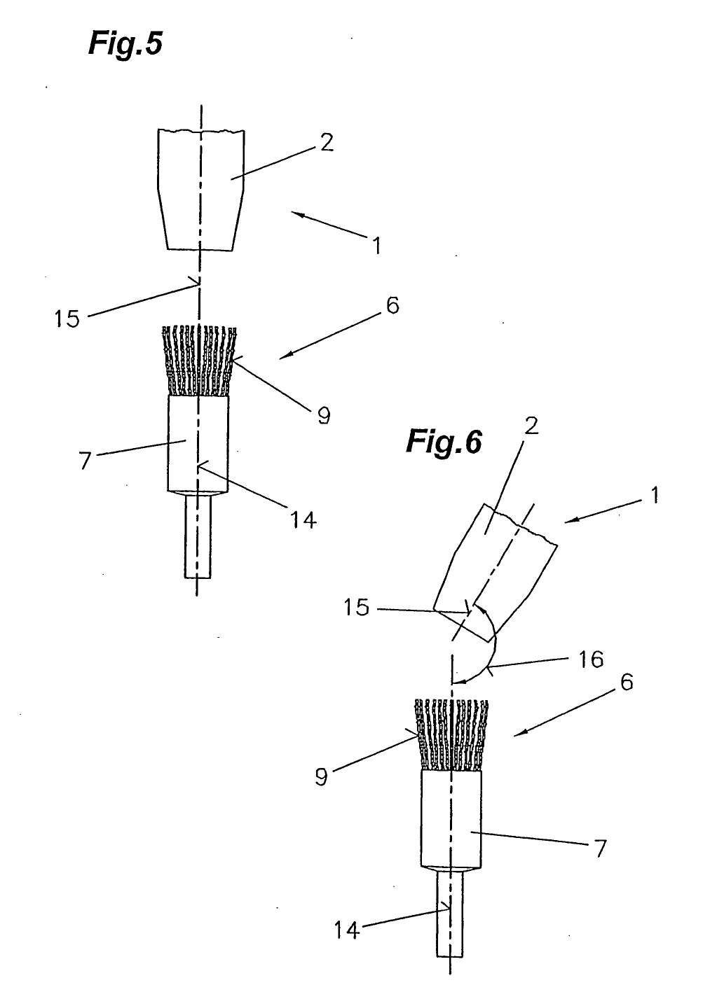

In the cleaning device or tool 6 illustrated in FIG. 5, the gas nozzle 2 is oriented relative to the brush 7 in a manner that the central axis 14 of the brush 7 is arranged in alignment with the central axis 15 of the gas nozzle 2 and the welding torch 1, respectively. In the further exemplary embodiment according to FIG. 6, the gas nozzle 2, and welding torch 1, are oriented relative to the brush 7 in a manner that the central axis 14 of the brush 7 is arranged relative to the central axis 15 of the gas nozzle 2 at an angle 16 of between 120° and 160°.

In a preferred manner, the welding torch 1 and the brush 7 perform a rotational movement, with a diametrically opposed movement being preferred. It is, however, also feasible that only one of the two elements and, in particular, the brush 7, carries out a rotational movement. In the event of an angularly arranged welding torch 1 according to FIG. 6, the welding torch 1 carries out an eccentric rotational movement. It is, thus, ensured in an an advantageous manner that the the bristles 9 are able to adapt to the shape of the gas nozzle 2 in the interior of the gas nozzle 2. It is, thereby, feasible to clean also those gas nozzles 2 which have conically tapering shapes. The angular arrangement of the gas nozzle 2 relative to the bristles 9, in fact, causes the bristles 9 to contact the gas nozzle 2 along its conically tapering extension. If a perpendicular orientation were used with such conically tapering gas nozzles 2, the bristles 9 would enter through the opening of the gas nozzle 2 yet not extend along the inner wall of the gas nozzle 2, so that only limited cleaning, i.e., cleaning of the end regions of the gas nozzle 2 and the contact tube 4 and the nozzle assembly 3 would be feasible.

It is, furthermore, feasible that the brush 7 and, in particular, the bristles 9 have different shapes. The bristles 9 may, for instance, have different lengths, with different coherent regions being preferably provided. In this connection, it is possible to make the bristles 9 in a region in the center of the brush 7 shorter than in the peripheral edge region. It is also possible to provide shorter bristles 9 in the region of the brush 7, that is congruent with the housing of the gas nozzle 2. Another option would be to arrange a projection in the edge region of the brush 7, which projection is difficult to elastically deform so as to allow for only slight pressing apart of the bristles 9 as the latter are being pressed or forced on the gas nozzle 2 or welding torch 1.

It is essential to the cleaning device according to the invention that the brushes 7, or synthetic brushes, are constructed in a manner that abrasives 11 are incorporated in the bristles 9, wherein new grain or abrasives 11 are constantly released by the wear of the brushes 7 so as to ensure a uniform grinding effect. The synthetic brushes are highly elastic and flexible, thus allowing for better cleaning than metal brushes on sites that are difficult to accede, such as the interior of the welding torch. Moreover, the surfaces of the parts to be cleaned such as, for instance, the gas nozzle 2, the contact tube 4, the nozzle assembly 3 etc. will not become as heavily damaged or scratched as by metal brushes known from the prior art. If the surface is heavily scratched, weld spatter 5 will even better adhere in a welding process than in the event of a smooth surface.

1: A gas nozzle for a welding torch, which is made of copper or a copper alloy, comprising an artificially produced patina layer (8) at least on a partial area of its surface.

2: A welding torch including a gas nozzle, a nozzle assembly and a contact tube, wherein the gas nozzle and/or the nozzle assembly and/or the contact tube are made of copper or a copper alloy, the gas nozzle (2) and/or the nozzle assembly (3) and/or the contact tube (4) comprising an artificially produced patina layer (8) at least on a partial area of the respective surface.

3: A gas nozzle and a welding torch according to claim 1, wherein said patina layer (8) has a thickness ranging between 50 and 200 μm.

4: A gas nozzle and a welding torch according to claim 1, wherein said patina layer (8) is provided over the entire surface.

5: A cleaning device for a welding torch and, in particular, its gas nozzle, which includes a brush provided with bristles for cleaning the welding torch of weld spatter, wherein the bristles (9) of the brush (7) are formed of a very soft, elastic material, preferably a synthetic material, and that abrasives (11) are embedded in the bristles (9).

6: A cleaning device according to claim 5, wherein the bristles (9) are provided with a coating (10) in which said abrasives (11) are embedded.

7: A cleaning device according to claim 5, wherein the diameter (12), or outer periphery, of the brush (7) is larger than the diameter (13), or outer periphery, of the gas nozzle (2) of the welding torch (1).

8: A cleaning device according to claim 5, wherein the bristles (9) of the brush (7) have a length ranging between 15 mm and 50 mm.

9: A cleaning device according to claim 5, wherein the central axis (14) of the brush (7) in the cleaning position is arranged in alignment with the central axis (15) of the gas nozzle (2) and welding torch 1, respectively.

10: A cleaning device according to claim 5, wherein the central axis (14) of the brush (7) in the cleaning position encloses an angle (16) of between 120° and 160° with the central axis of the gas nozzle (2) and welding torch (1), respectively.

11: A cleaning device according to claim 5, wherein the brush (7) carries out a rotational movement in respect to the gas nozzle (7) and welding torch (1), respectively, preferably in the counter direction to an optional rotational movement of the gas nozzle (7) and welding torch (1), respectively.

12: A cleaning device according to claim 11, wherein the brush (7) carries out an eccentric rotational movement.

13: A cleaning device according to claim 5, wherein the bristles (9) have different lengths with different coherent regions being preferably provided.

14: A cleaning device according to claim 13, wherein the bristles (9) in a region in the center of the brush (7) are shorter than in the peripheral edge region or vice versa.

15: A cleaning device according to claim 13, wherein the region of the brush (7) corresponding to the projection of the gas nozzle (2) has shorter bristles (9) than the remaining region of the brush (7).

16: A cleaning device according to claim 5, wherein the bristles (9) of the brush (7) are comprised of one, or a combination, of the materials silicon carbide, polyvinyl chloride, nylon, polyamide, polypropylene, polyethylene or fibre.

17: A cleaning device according to claim 5, wherein the bristles (9) are designed to be corrugated or plaited.

18: A cleaning device according to claim 5, wherein a projection surrounding the bristles (9) over a partial region of their length is arranged in the edge region of the brush (7).
